(19) United States
(12) Patent Application Publication
(10) Pub. No.: US 2012/0253936 A1
(43) Pub. Date: Oct. 4, 2012

(54) SYSTEM AND METHOD FOR PROVIDING COMMERCIAL INFORMATION TO LOCATION-AWARE DEVICES

(76) Inventor: Erik G. Swenson, Orono, MN (US)

(21) Appl. No.: 13/394,752

(22) PCT Filed: Jun. 18, 2009
(86) PCT No.: PCT/US09/47776

§ 371 Date: Jun. 25, 2012

Related U.S. Application Data
(60) Provisional application No. 61/073,938, filed on Jun. 19, 2008.

(51) Int. Cl. G06Q 30/02

(52) U.S. Cl. 705/14.58; 705/14.66

(57) ABSTRACT

A method of delivering advertisements to a location-aware device includes determining current time, date, and physical location of the location-aware device; determining user selected proximity limit; determining user selection data criteria regarding which advertisements the user desires; and filtering all available advertisements for subset information matching the current time, date, physical location, proximity limit, and selection criteria. The user can receive advertisements that the user desires to receive on the location-aware device.

### PRIORITY CLAIM

The present application claims the benefit of U.S. Provisional application 61/073,938, filed on Jun. 19, 2008, which is incorporated by reference.

### TECHNICAL FIELD

The present invention relates generally to the field of commercial information, and more particularly to a system and method of providing commercial information to location-aware devices.

### BACKGROUND

The Internet provides consumers with a vast resource. Consumers can shop on-line, research and view content and commercial information, and communicate via the Internet. Most commercial internet sites are supported by advertisements. When a consumer, or user, accesses a website, typically some content, or information, is provided to the consumer along with some form of advertisement or advertisements. The advertisements may be random, may be automatically selected by the service based on the content the user is viewing, or may be selected by past history of the user. In most cases the advertisements are targeted at the consumer based on some determination about who the consumer is or what the consumer might desire.

Many mobile computing devices, such as cell phones, personal digital assistants (PDA), and navigational systems are capable of receiving commercial information. For example, many PDAs include an internet browser. Indeed, users can use these devices to shop on-line, research and view content and commercial information and communicate via the Internet. Outside of Internet browsing, advertisements can be delivered to these mobile devices as well, which is currently disadvantageous. One disadvantage to delivering advertisements to mobile devices is that a consumer does not want to be inundated with advertisements, or other information. One solution has been to allow a user to opt in or out of advertisement delivery to its mobile device. Such a solution still has disadvantages. One such disadvantage is that when a user does opt in, they are still inundated with advertisements. Another disadvantage is that the consumer is receiving advertisements the consumer may not want to receive. This is particularly disadvantageous with mobile devices because users do not want to receive unwanted information or advertisements to such a device.

Therefore, improvements are desirable.

### SUMMARY

In accordance with the present invention, the above and other problems are solved by the following:

In one aspect of the present invention, a method of delivering commercial information to a location-aware device is disclosed. The method includes determining real time data criteria; determining user static data criteria; determining user selection data criteria; filtering all available commercial information for subset information matching the real time data criteria, the static data criteria, and the selection data criteria; and delivering the subset information to the location-aware device. The user can receive commercial information that the user desires to receive on the location-aware device.

In another aspect of the present invention, a method of delivering advertisements to a location-aware device is disclosed. The method includes determining current time, date, and physical location of the location-aware device; determining user selected proximity limit; determining user selection data criteria regarding which advertisements the user desires; and filtering all available advertisements for subset information matching the current time, date, physical location, proximity limit, and selection criteria. The user can receive advertisements that the user desires to receive on the location-aware device.

In another aspect of the present invention, a location-aware device for receiving advertisements is disclosed. The location-aware device includes a module for receiving advertisements that have been filtered according to a user's personal selections of interested advertisements, the current time and date, the current location of the device, and the proximity limit selected by the user.

The invention may be implemented as a computer process, a computing system, or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

A more complete appreciation of the present invention and its scope may be obtained from the accompanying drawings, which are briefly described below, from the following detailed descriptions of presently preferred embodiments of the invention and from the appended claims.

### BRIEF DESCRIPTION OF THE DRAWINGS

Referring now to the drawings in which like reference numbers represent corresponding parts throughout:

FIG. 1 is an exemplary embodiment of a schematic representation of methods and systems for delivering commercial information to a location aware mobile device according to the present disclosure;

FIG. 2 is an exemplary embodiment of a schematic representation of a computing system that may be used to implement aspects of the present disclosure;

FIG. 3 is an exemplary embodiment of a schematic representation for implementing commercial information delivery to mobile devices according to the present disclosure;

FIG. 4 is an exemplary embodiment of a schematic representation of types of data according to the present disclosure;

FIG. 5 is an exemplary embodiment of a process flow diagram illustrating a method for managing a user account according to the present disclosure;

FIG. 6 is an exemplary embodiment of a schematic representation of types of user selections according to the present disclosure;

FIG. 7 is an exemplary embodiment of a schematic representation for implementing commercial information delivery to mobile devices according to the present disclosure;

FIG. 8 is an exemplary embodiment of a process flow diagram illustrating a method of filtering commercial information according to the present disclosure; and

FIG. 9 is an exemplary embodiment of a process flow diagram illustrating a method of filtering commercial information according to the present disclosure.

### DETAILED DESCRIPTION

Various embodiments presented herein will be described in detail with reference to the drawings, wherein like reference numerals represent like parts and assemblies throughout the several views. Reference to various embodiments should not be construed as limiting the scope of covered subject matter, which is limited only by the scope of the claims attached hereto. Additionally, any examples set forth in this specification are not intended to be limiting and merely set forth some of the many possible embodiments.

In general the present disclosure relates to methods and systems that provide commercial information to location-aware devices. Certain computing devices, such as PDAs, cell phones, and navigational systems can determine their location and are typically mobile. In other words, such a device, or other device, may use GPS, signal triangulation, reference to known locations, an event association, etc., to determine its physical location. Once known, a user of a location-aware device, or mobile device, may desire to receive certain information via that device that is relevant to the known physical location. The methods and systems described herein allow a user to determine which information he desires to be delivered to his device based on the device's physical location. The methods and systems described herein can also allow a commercial entity to additionally determine which information it desires to be delivered to the user's device.

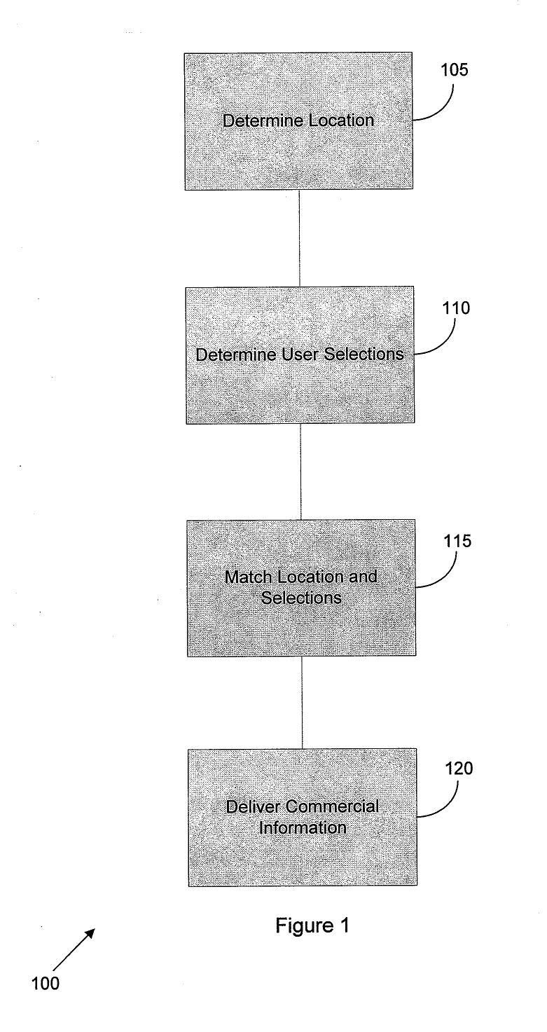

Referring now to the Figures, FIG. 1 depicts a block diagram representing a method and system 100 that provides for commercial information to be delivered to location-aware devices. A location module 105 determines a device's physical location. For example, a PDA with GPS capabilities can determine its own location, or the system can determine its location, and send that information to the location module 105. A selection module 110 determines a user's selection. For example, a user can pre-select commercial information that he is interested in receiving on his location-aware device. By the term “commercial information”, it is meant information related to commercial enterprises. Such information can include advertisements, product information, restaurant menus or reservation schedules, hours of operation, directions to a commercial establishment, and other information related to commercial enterprises. A match module 115 determines which commercial information from the selection module 110 matches the physical location from the location module 105. A delivery module 120 delivers the matched information to the location-aware device from the match module 115.

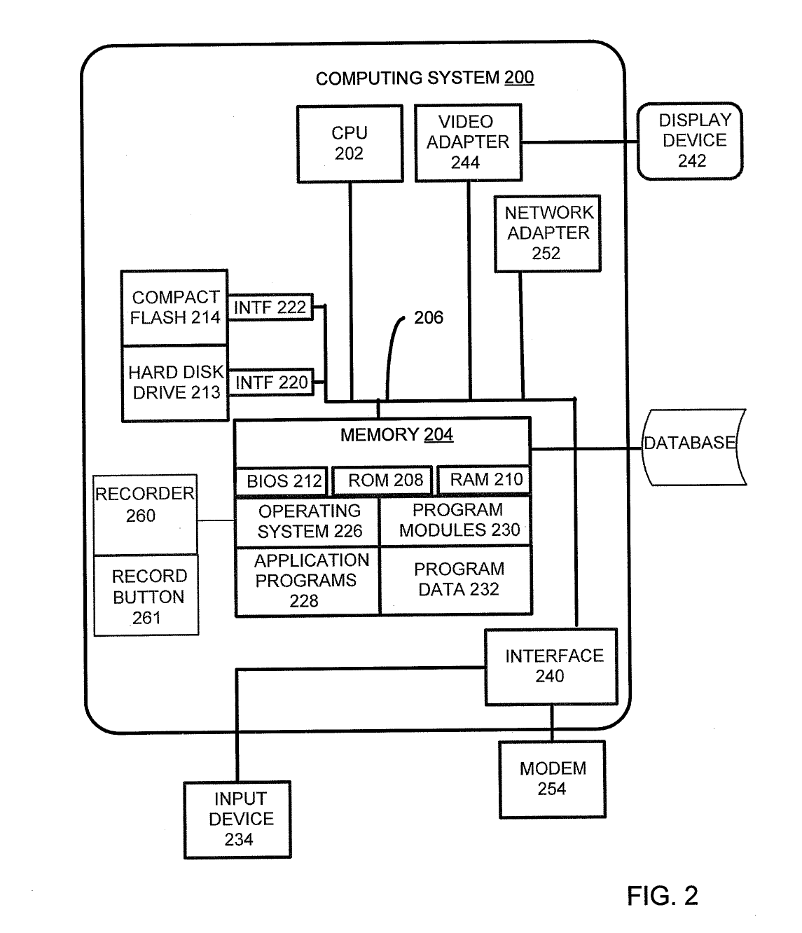

FIG. 2 and the following discussion are intended to provide a brief, general description of a suitable computing environment in which the invention might be implemented. Although not required, the invention is described in the general context of computer-executable instructions, such as program modules, being executed by a computing system. Generally, program modules include routines, programs, objects, components, data structures, etc. that perform particular tasks or implement particular abstract data types.

Those skilled in the art will appreciate that the invention might be practiced with other computer system configurations, including handheld devices, palm devices, multiprocessor systems, microprocessor-based or programmable consumer electronics, network personal computers, minicomputers, mainframe computers, and the like. The invention might also be practiced in distributed computing environments where tasks are performed by remote processing devices that are linked through a communications network. In a distributed computing environment, program modules might be located in both local and remote memory storage devices.

Referring now to FIG. 2, an exemplary environment for implementing embodiments of the present invention includes a general purpose computing device in the form of a computing system 200, including at least one processing system 202. A variety of processing units are available from a variety of manufacturers, for example, Intel or Advanced Micro Devices. The computing system 200 also includes a system memory 204, and a system bus 206 that couples various system components including the system memory 204 to the processing unit 202. The system bus 206 might be any of several types of bus structures including a memory bus, or memory controller; a peripheral bus; and a local bus using any of a variety of bus architectures.

Preferably, the system memory 204 includes read only memory (ROM) 208 and random access memory (RAM) 210. A basic input/output system 212 (BIOS), containing the basic routines that help transfer information between elements within the computing system 200, such as during start-up, is typically stored in the ROM 208.

Preferably, the computing system 200 further includes a secondary storage device 213, such as a hard disk drive, for reading from and writing to a hard disk (not shown), and/or a compact flash card 214.

The hard disk drive 213 and compact flash card 214 are connected to the system bus 206 by a hard disk drive interface 220 and a compact flash card interface 222, respectively. The drives and cards and their associated computer-readable media provide nonvolatile storage of computer readable instructions, data structures, program modules and other data for the computing system 200.

Although the exemplary environment described herein employs a hard disk drive 213 and a compact flash card 214, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 213, compact flash card 214, ROM 208, or RAM 210, including an operating system 226, one or more application programs 228, other program modules 230, and program data 232. A user may enter commands and information into the computing system 200 through an input device 234. Examples of input devices might include a keyboard, mouse, microphone, joystick, game pad, satellite dish, scanner, digital camera, touch screen, and a telephone. These and other input devices are often connected to the processing unit 202 through an interface 240 that is coupled to the system bus 206. These input devices also might be connected by any number of interfaces, such as a parallel port, serial port, game port, or a universal serial bus (USB). A display device 242, such as a monitor or touch screen LCD panel, is also connected to the system bus 206 via an interface, such as a video adapter 244. The display device 242 might be internal or external. In addition to the display device 242, computing systems, in general, typically include other peripheral devices (not shown), such as speakers, printers, and palm devices.

When used in a LAN networking environment, the computing system 200 is connected to the local network through a network interface or adapter 252. When used in a WAN networking environment, such as the Internet, the computing system 200 typically includes a modem 254 or other means, such as a direct connection, for establishing communications over the wide area network. The modem 254, which can be internal or external, is connected to the system bus 206 via the interface 240. In a networked environment, program modules depicted relative to the computing system 200, or portions thereof, may be stored in a remote memory storage device. It will be appreciated that the network connections shown are exemplary and other means of establishing a communications link between the computing systems may be used.

The computing system 200 might also include a recorder 260 connected to the memory 204. The recorder 260 includes a microphone for receiving sound input and is in communication with the memory 204 for buffering and storing the sound input. Preferably, the recorder 260 also includes a record button 261 for activating the microphone and communicating the sound input to the memory 204.

A computing device, such as computing system 200, typically includes at least some form of computer-readable media. Computer readable media can be any available media that can be accessed by the computing system 200. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

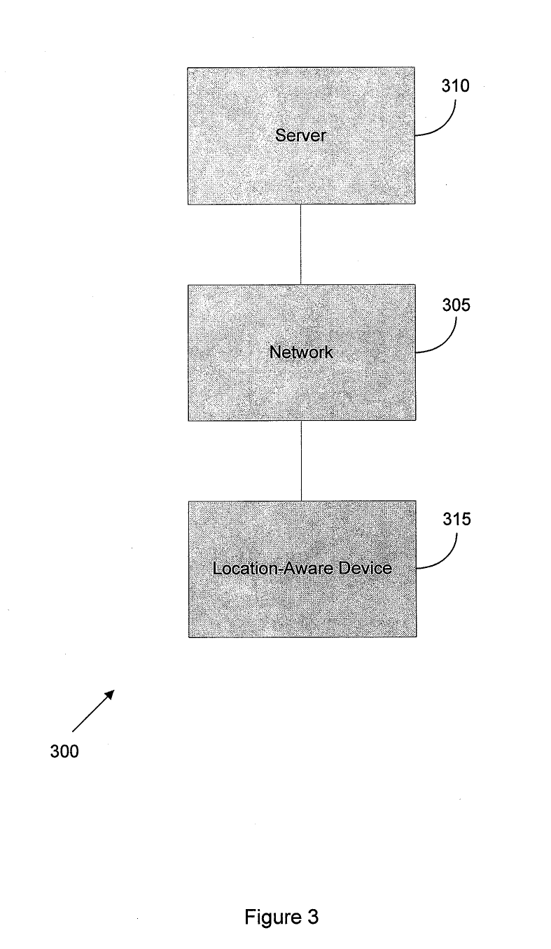

FIG. 3 is a block diagram illustrating an example system 300 for implementing commercial information delivery to mobile devices. Preferably, the system 300 includes a network 305, at least one server 310, and at least one location-aware device 315. Preferably, the server 310 includes commercial information. Preferably, the location-aware device 315 is enabled to receive the commercial information. The network facilitates communication between the server 310 and the location-aware device 315.

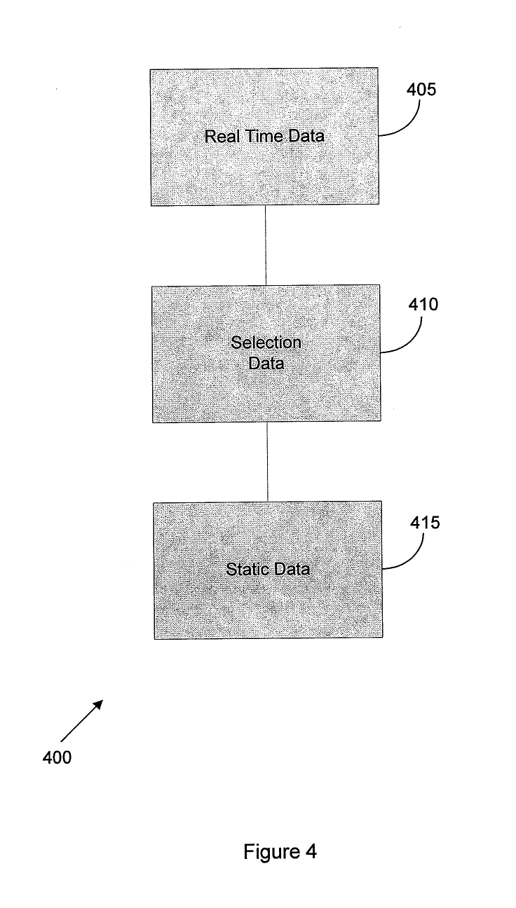

FIG. 4 is a block diagram illustrating different types of data 400 that can be used in the delivery of commercial information to a location-aware device. A real time module 405 includes real time data. Such data can include a device's physical location and the present date and time. A selection module 410 includes selection data. Selection data includes information desired, or selected, by the user. The selection data can be based on selection, or choices, previously made by the user. The user can create a list or hierarchy of its selections that the system can use to determine or filter relevant commercial information for delivery. For example, a user can select local coffee shops. The selection data can include, for example, that a user is interested in electronics, flat-screen LCDs, diapers, baby supplies, cars, furniture, local restaurants, or other information.

A static module 415 includes static information. Static information is typically information that is not constantly changing and can include demographic information about the user, such as the user's age, address, income level, etc. Static information can also be used as a basis for commercial information delivery.

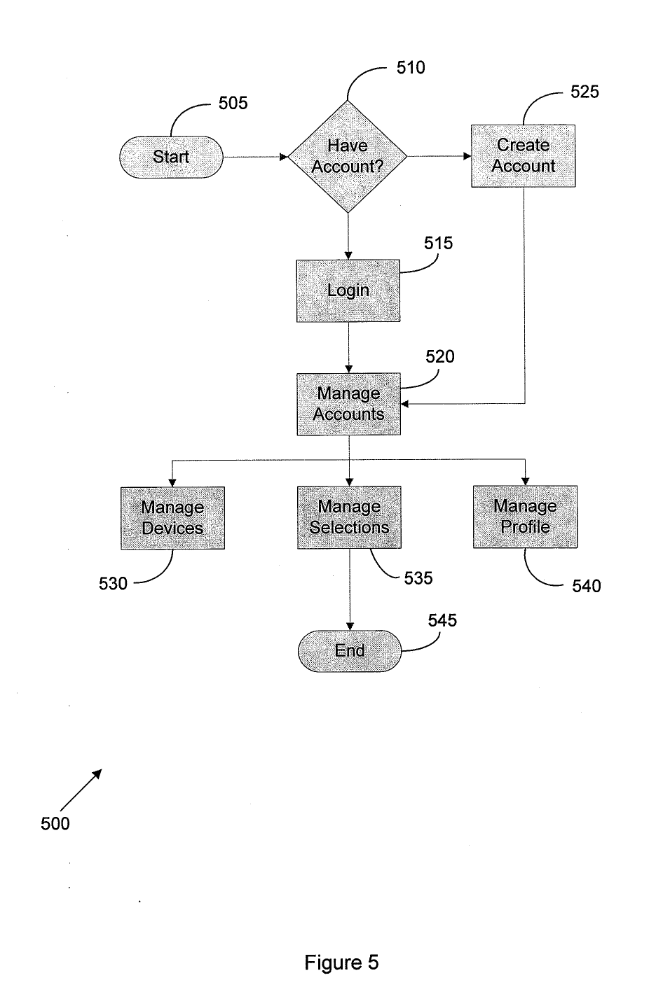

FIG. 5 is an exemplary process flow diagram of a user management system 500 for the user to manage its account. The process flow begins at start 505. An account operation 510 determines if the user has an account. If the account operation 510 determines that the user has an account, operational flow branches “YES” to a login module 515. The login module 515 logs the user into the system 500. A manage account module 520 allows the user to manage his account.

Referring back to the account operation 510, if the account operation 510 determines that the user does not have an account, operational branches “NO” to a create module 525. The create module 525 creates an account for the user. Operational flow continues to the manage account module 520.

Preferably, the manage account module 520 branches into a device module 530, a selection module 535, and a profile module 540. The device module 530 allows a user to manage his devices. A user may have multiple devices under his account. For example, a user may have a PDA and a navigational system in his vehicle. Under the device module 530, the user can establish which device or devices to include for commercial information delivery. The user initially may list his available devices with appropriate network identification. Later the user may enable or disable certain devices depending on his current desires. For example, during the work week, the user may disable his PDA on the network for commercial information delivery. On weekends, the user may enable his PDA on the network to receive certain commercial information.

The selection module 535 allows a user to manage his selections, such as local coffee shops. The selections may be numerous, may be organized graphically, in a list or hierarchy, may be suggested to a user, or etc. The profile module 540 allows a user to manage his profile. The profile can include demographic information, account information, family information, or other normal data that remains relatively constant.

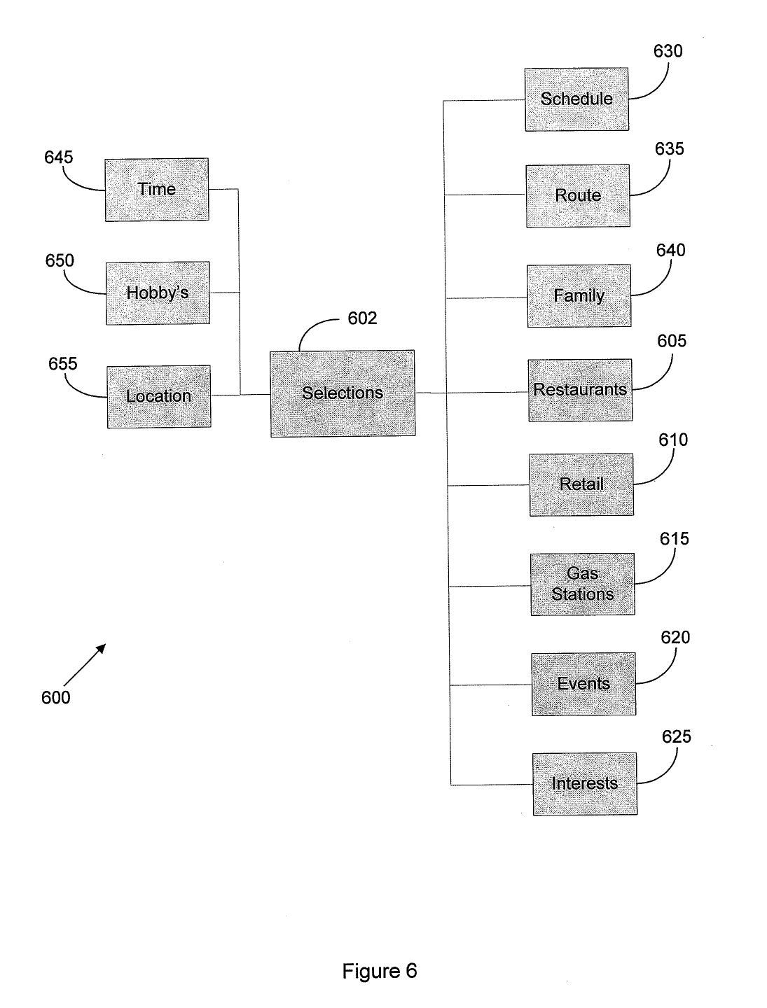

FIG. 6 is a block diagram illustrating a selection system 600. The selection system 600 includes selections 602 that a user may make. A user may select restaurants 605. Once selected, restaurants could be divided into sub-segments such as type of restaurant, menu choices, coffee shops, whether the restaurant is independent or a chain of restaurants, etc. A user may select retail 610. Once selected, retail could be divided into sub-segments such as home improvement, electronics, commodity goods, baby supplies, groceries, etc. A user may select gas stations 615. Once selected, gas stations could be divided into sub-segments such as by brand, price, or whether it includes a convenience store. The selection system 600 can include numerous layers and sub-layers to drill down to any level of detail. Selections 602 can also include events 620, interests 625, schedule 630, route 635, family 640, time, 645, hobby's 650, and location 655. The selections 602 illustrated are meant to be examples only and are not intended to limit the disclosure.

In addition, a user may input his schedule or the system could be associated with his calendar to associate events to information or allow the user to select certain event triggers that may allow commercial information delivery. For example, a user may desire to receive lots more commercial information delivery to his device while on vacation in an unknown area. In addition, the user may be interested in different types of commercial information while on vacation such as hotels and rental car facilities. Furthermore, a user may input his hobbies or interests that can be used to derive the selections for the user.

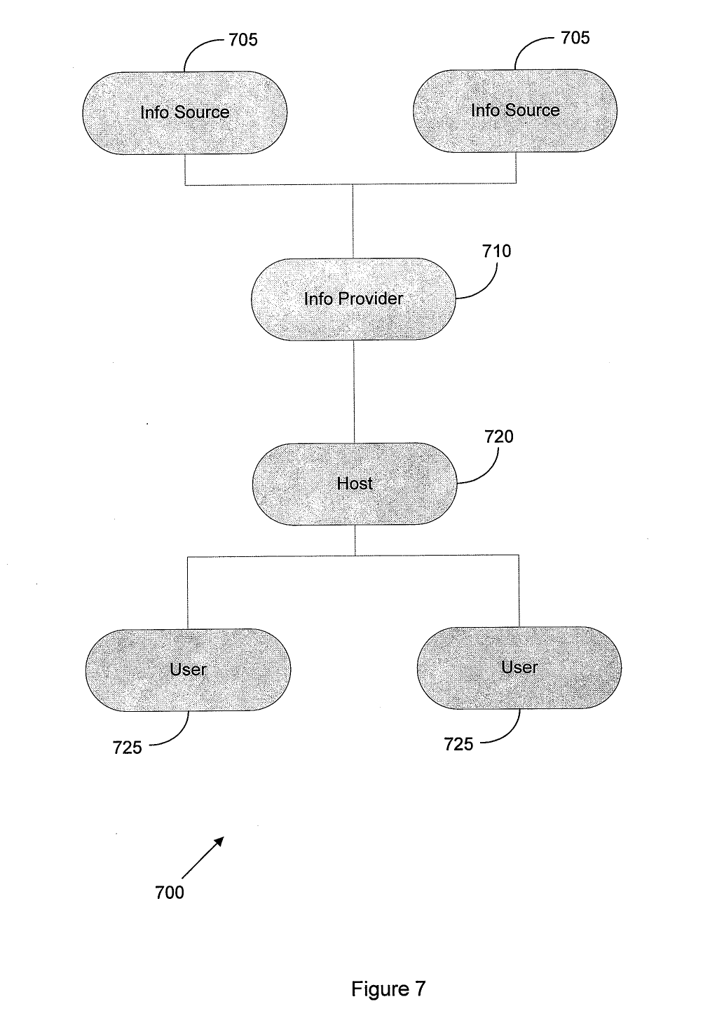

FIG. 7 is an exemplary diagram illustrating a multi-party relationship 700 to facilitate delivery of commercial information to location-aware devices. Preferably, the relationship 700 includes at least one information source 705. The information source can be a retailer who desires to advertise to users. The relationship 700 also includes at least one info provider 710. The info provider 710 aggregates the information sources 705. The relationship 700 includes at least one host 720 and at least one location-aware device 725. The host 720 delivers commercial information to a location-aware device 725.

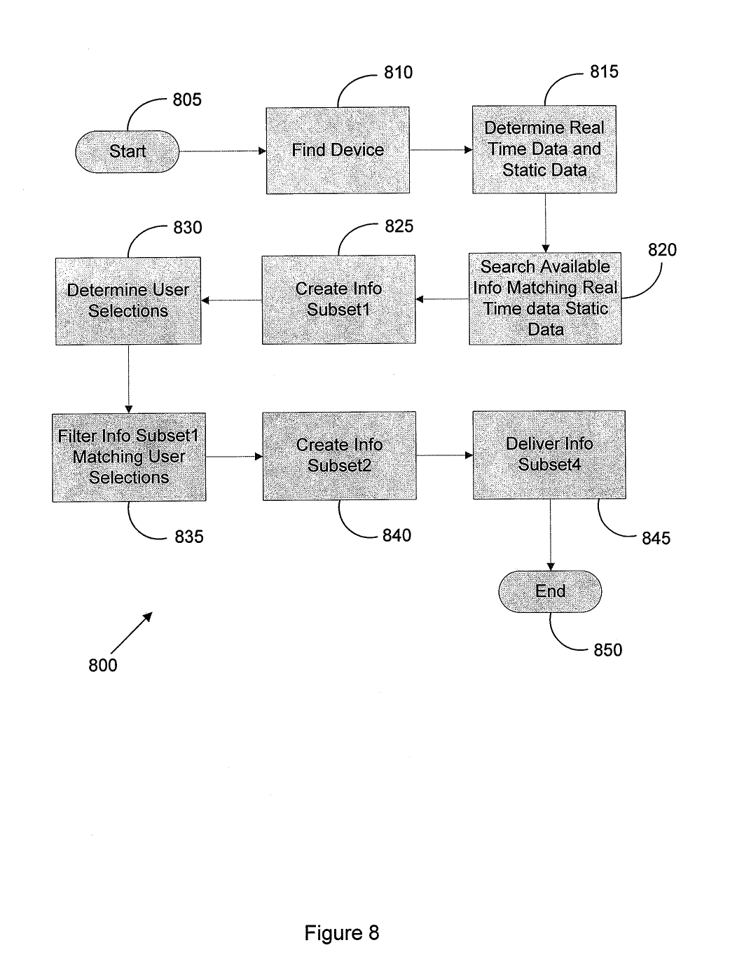

FIG. 8 is an exemplary process flow diagram of methods and systems 800 for delivering commercial information to location-aware devices. The flow diagram begins at start 805. A find module 810 locates a location-aware device and determines its current location. A data module 815 determines other real-time information, such as the current time and date, and static information, such as the user's desired proximity limit. A search module 820 searches all available information matching the real time data and static data. For example, a user may have determined that it only wished to receive commercial information on Saturdays and Sundays and information that is within a 1 mile radius of the user. A first create module 825 creates a subset1 of information. The subset1 of information includes all commercial information that matches the real time data and static data from the data module 815. For example, a restaurant located in a downtown area may only be open Monday through Friday. Using the above example of the user only wanting data on Saturdays and Sundays, this restaurant would have been filtered out by the search module 820 and not included in subset1. In addition, all commercial information that is beyond the 1 mile radius is filtered out and not included in subset1.

A selection module 830 determines a user's selections. A filter module 835 filters the subset1 information that matches the user's selections. A second create module 840 creates a subset2 of information. For example, a user may have selected only restaurants that have Mexican food. The subset2 of information would now include only restaurants having Mexican food that were open on Saturday and Sunday and were within 1 mile of the user. A delivery module 845 delivers the subset2 information to the location-aware device. The process flow ends 850.

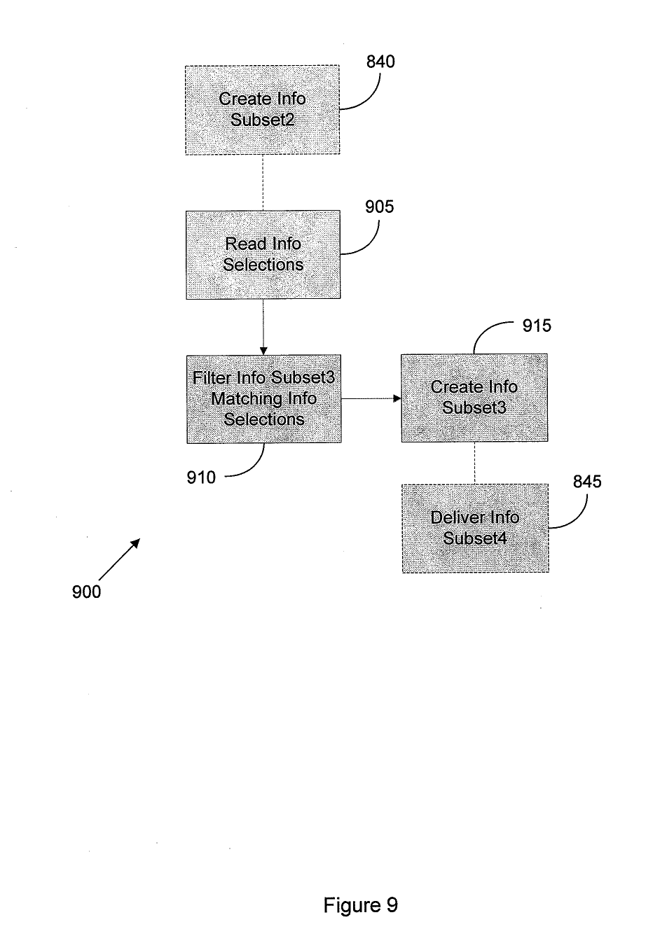

FIG. 9 is an exemplary process flow diagram of methods and systems 900 for delivering commercial information to location-aware devices. The system 900 includes an additional, optional, component that can be added on to FIG. 8 after the second create module 840 and before the deliver module 845. Preferably, the system 900 includes a read module 905. The read module 905 reads the selections of the commercial information providers, as opposed to the user. For example, a particular advertiser may not want to deliver its ads to a male. The particular advertiser may sell only women's clothes, and although a man may purchase such clothes as a gift so someone else, the advertiser determines that it is not willing to pay for such ads. It is only willing to pay for ads delivered to females between the ages of 14 and 45. A filter module 910 filters the info from subset2 according to the selections of the info provider. A create module 915 would create a subset3 to include only the further filtering. The deliver module 845 of FIG. 8 would then deliver subset3 to the location-aware device.

The methods and system describe herein may better be understood by way of application examples. Referring to FIGS. 5 and 8, in one such application example, a user logs into his account at login module 515. In the device module 530, the user has previously listed his PDA and car's navigation system as available devices. In the profile module 540, the user has selected that he only wants information within a 5 mile radius of his devices, that he only wants information on Saturdays, Sundays, and after 6 pm on weekdays. The user has also selected that he only wants the information sent to one of his devices and if he is in his car, that device should be his car's navigation system, but if he is not in his car, that device should be his PDA. In the selection module 535, the user has selected independent restaurants, art galleries having pottery, and baby stores.

It is Saturday morning and the user leaves his house in his car, the find module 810 locates the car and tracks its route or progress as the user drives. The data module 815 determines the current location of the car, the current time and date, and retrieves all the user's static information, such as the proximity limit of 5 miles. The search module 820 searches all the available commercial information for information matching the current location of the car within a 5 mile radius, and matching the day and time. Such information may be vast and include restaurants, gas stations, electronic stores, massage parlors, coffee shops, art galleries, clothing stores, etc. . . . Such information is also constantly changing as the car the car is moving and changing current locations.

The first create module 825 creates subset1 of the information. A selection module 830 determines the user's selections. The filter module 835 filters subset1 of the information to find information matching the user's selections of independent coffee shops, art galleries having pottery, and baby stores. The second create module 840 creates a subset2 of information matching all the criteria. The deliver module 845 delivers the information to the user's navigation system in his car.

In one example, nothing is delivered to the user's navigation system because no information matches all the criteria. In another example, two matches are delivered to the user's navigation system. The navigation system displays the ads for two independent restaurants that are within a 5 mile radius. The navigation system may also include an option to navigate the user to the restaurant. Further, the system may include an electronic coupon for a free a cup of coffee if the user stops in the next 15 minutes. The system may allow the user to pull up the menu of the restaurant to decide if the user is interested. If the user is interested, the system may allow the user to hit a button to make a reservation at the restaurant as he approaches.

Referring to the above example and including FIG. 9, of the two independent restaurants, the filter module 910 filters out one of the restaurants because it only wants to deliver ads to consumers for breakfast between 6 am and 8 am. The current time is 10 am, and the filter module 910 filters out the restaurant based on the restaurants selection. Thus, only the remaining single restaurant is delivered by the delivery module 845 to the navigation system of the user.

These are examples of commercial information being delivered to a location-aware device. It is noted that the method and systems herein would run continuously filtering information that matches all of the criteria to deliver only selected information in a timely manner to devices within a certain proximity. The information is dynamic and constantly changing. As such, as the location-aware device is mobile, the information to that device can be constantly changing and updating.

The methods and systems herein have numerous advantages. One such advantage is that the information delivered to the mobile device can be greatly reduced by filtering based on real-time data, static data, and user data. So, while the amount of commercial information is vast and numerous, the amount delivered the mobile device can be very small, and the users get only the information they desire. They are not inundated with information, but receive small amounts of data that they select and that are relevant to their interests. As such, users are likely to desire such information. Another such advantage is that advertisers are assured that their ads are getting to very targeted and interested users. Another such advantage is that smaller businesses may be able to afford to advertise. Rather than having to pay for a large, blanketed advertising campaign, they can pay for targeted advertising that is effective. Another advantage is that advertisers can determine criteria under which they are interested in delivering ads to users.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A method of delivering commercial information to a location-aware device, the method comprising:
determining real time data;
determining user static data;
determining user selection data;
filtering all available commercial information for subset information matching the real time data, the static data, and the selection data; and
delivering the subset information to the location-aware device;
wherein a user receives commercial information that the user desires to receive on the location-aware device.

2. The method according to claim 1, further comprising:
determining info provider selection criteria; and
filtering the subset information into a second subset information that matches the provider selection criteria;
wherein the info provider can target specific users.

3. The method according to claim 1, wherein determining real time data includes determining location and current date and time.

4. The method according to claim 1, wherein determining static data includes determining a proximity limit.

5. The method according to claim 1, wherein determining user selection data criteria includes data specifically selected by the user as data the user desires to receive on his location-aware device.

6. A method of delivering advertisements to a location-aware device, the method comprising:
determining current time, date, and physical location of the location-aware device;
determining a user selected proximity limit;
determining user selection data criteria regarding which advertisements the user desires; and
filtering all available advertisements for subset information matching the current time, date, physical location, proximity limit, and selection criteria;
wherein the user can receive advertisements that the user desires to receive on the location-aware device that are relevant to a user's location and current time and that the user desired to receive.

7. The method according to claim 6, further comprising:
determining info provider selection criteria; and
filtering the subset information into a second subset information that matches the provider selection criteria;
wherein the info provider can target specific users.

8. A location-aware device for receiving advertisements, the location-aware device comprising:
a module for receiving advertisements that have been filtered according to a user's personal selections of interested advertisements, the current time and date, the current location of the device, and the proximity limit selected by the user.
